(19) United States
(12) Patent Application Publication
(10) Pub. No.: US 2007/0093080 A1
(43) Pub. Date: Apr. 26, 2007

(54) Pin contact with direct in-line connection to equalization component

(75) Inventors: William John MacKillop, Naperville, IL (US); James Friedhof, Hemet, CA (US)

Correspondence Address: HOGAN & HARTSON L.L.P., 1999 AVENUE OF THE STARS, SUITE 1400, LOS ANGELES, CA, 90067, US

(73) Assignee: Deutsch Engineered Connecting Devices

(21) Appl. No.: 11/496,005

(22) Filed: Jul. 28, 2006

Related U.S. Application Data
(60) Provisional application No. 60/703,816, filed on Jul. 28, 2005.

(51) Int. Cl. H01R 39/00

(52) U.S. Cl. 439/13

(57) ABSTRACT

A contact pin for a connector. The contact pin is broken into first and second pin parts. An equalization component is directly and serially attached between the first and second pin parts, and no equalization components are mounted to a printed circuit board.

### RELATED APPLICATIONS

This application claims the benefit of U.S. provisional application 60/703,816, filed on Jul. 28, 2005.

### BACKGROUND OF THE INVENTION

1. Field of the Invention

The present invention relates to equalization in contacts, and in particular relates to a passive equalization component connected directly and serially to a contact pin of a connector.

2. Description of Related Art

High speed cables today implement passive and active (silicon based) equalization circuits in their connectors to modify the characteristics of the signal to either travel farther (i.e. use longer cables) or transmit faster (i.e. at a higher data rate). The equalization circuit is typically made of various combinations of resistors, capacitors and/or inductors. All known art involves the use of an intermediary circuit board, on which the equalization circuit components are mounted, that is attached to a cable connector on one side and the cable on the other side. US 2005/0112920, which discloses equalization components mounted on a circuit board and connected in parallel across the contacts, is indicative of the state of the art.

An exemplary prior art equalization circuit configuration is depicted in FIG. 1. Equalization components or circuit 10 are mounted on printed circuit board 12. Circuit board 12 is mounted between connector 14 and cable 16. Pins 18 from connector 14 attach to circuit board 12, and wires 20 from cable 16 attach to circuit board 12. An over molding 22 will typically be formed around the connector-cable interface.

Today's protocols (data transmission schemes) call for both physical (connector type, cable type and maximum length) and logical (minimum/maximum data rates, encoding schemes, etc.) layers. However, physical properties of the conductors (wires and pins) as well as the dielectric medium surrounding the conductors cause a tradeoff in the maximum data rate allowable to the distance that the signal can be transmitted. This proportionality is an inverse function: as the data rate increases the permissible transmission distance decreases. Conversely, a slower signal can be sent farther.

Ideally, the signal path impedance should be matched to the output impedance of the driver and the input impedance of the receiver. In reality, however, numerous impedance mismatches are introduced along the path.

The present invention overcomes these disadvantages of the prior art, and allows a signal to be sent both faster and farther.

### SUMMARY OF THE INVENTION

A contact pin for a connector according to the present invention comprises first and second pin portions, and an equalization component directly and serially attached between the first and second pin portions. In one embodiment, the equalization component comprises passive devices such as resistors and inductors that are soldered between the pin portions. The equalization component is not mounted to a printed circuit board.

In one embodiment, a cable connector is connected to the first pin portion and a cable wire is connected to the second pin portion, and the connector-pin-equalization-pin-wire signal path is co-linear. Preferably, the pin is removable from the cable wire.

The pins can be placed variably in a multi-pin configuration to optimize electrical characteristics. Equalization is applied on a pin-by-pin basis.

The present invention also provides a method for forming a connector having a contact pin with an in-line equalization component A contact pin is broken into two parts. A contact pin is then directly connected between the two parts, such as by soldering, without an intermediate component such as a circuit board.

Other features, advantages and embodiments of the invention will be apparent from the following detailed description, drawings and claims.

### BRIEF DESCRIPTION OF THE DRAWINGS

FIG. 1 is a prior art circuit configuration.

FIG. 2 is a cable-connector interface according to the present invention.

FIGS. 3A-C are exemplary schematics of passive equalization circuits.

FIGS. 4A-B depict a connector according to the present invention.

FIGS. 5A-B depict exemplary circular pin layouts according to the present invention.

FIGS. 6A-B depict exemplary rectangular pin layouts according to the present invention.

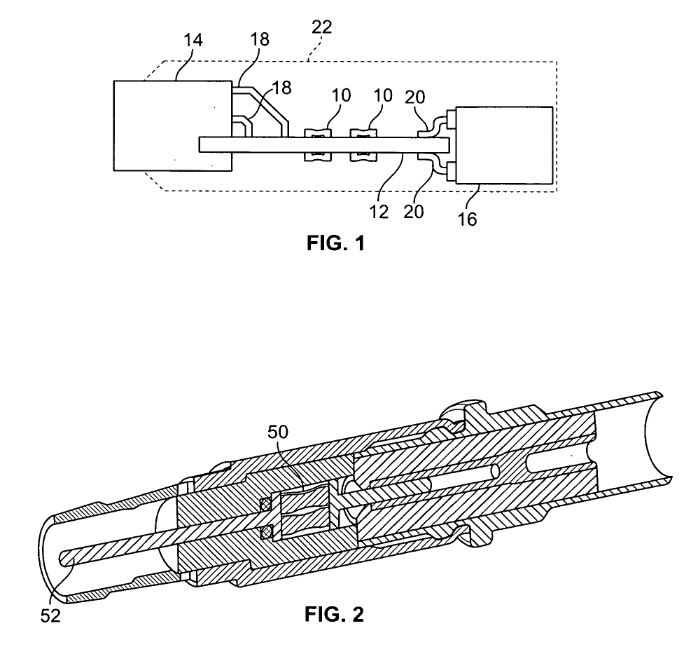

### DETAILED DESCRIPTION OF THE INVENTION

FIG. 2 depicts a cable-connector interface with passive equalization according to the present invention. Equalization components 50 are attached directly to pins 52. This approach provides for better performance as well as a more reliable assembly since fewer components are involved.

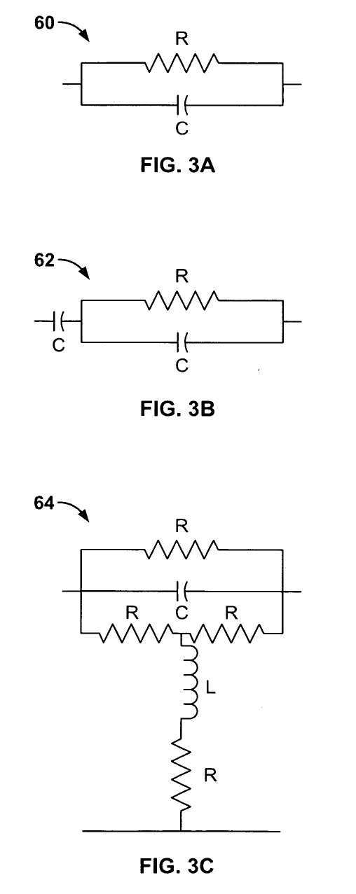

Equalization components 50 are directly connected to and added in-line (serially) with signal pin 52. Components 50 are directly connected to pin 52, without a printed circuit board mounting or any other sort of transition region. Equalization components 50 comprise a combination of passive components, typically a resistor or capacitor. Many combinations of passive components are suitable. Exemplary schematic representations of suitable equalization circuits are illustrated in FIGS. 3A-C. FIG. 3A depicts an R-C (resistor-capacitor) filter 60. FIG. 3B depicts a C-R-C filter 62. FIG. 3C depicts an L-R-C filter 64. Many other combinations of passive components are possible and within the scope of this invention.

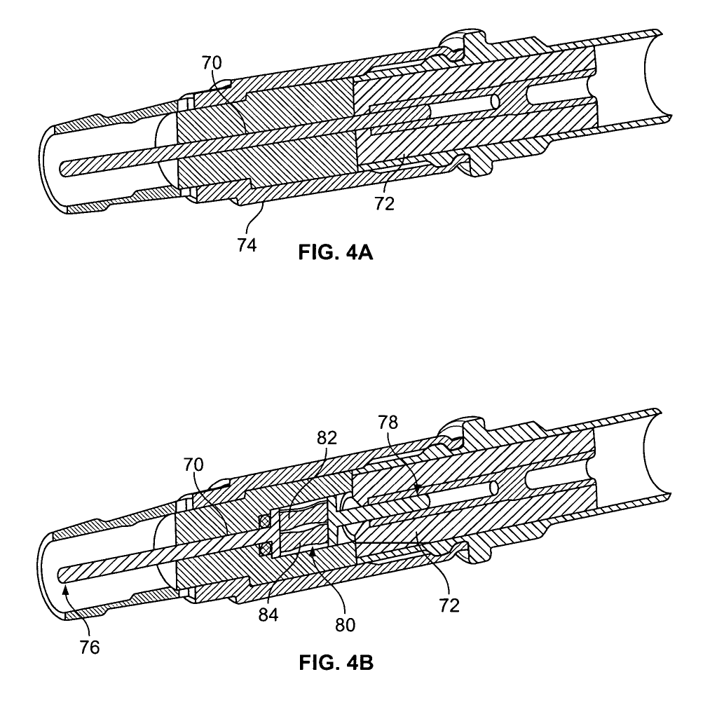

In order to configure equalization components 50 in-line with pin 52, in one embodiment, pin 52 is broken and then electrically connected to the combination of components. FIG. 4A depicts a standard pin 70 secured within a pin retainer 72 and encased within a connector shell 74. In FIG. 4B, pin 70 is broken into a front end 76 and a rear end 78. Equalization components 80 are then directly, coaxially and linearly connected between front end 76 and rear end 78. Equalization components 80 may comprise, for example, a chip resistor 82 in parallel with a chip capacitor 84. Although in parallel with each other, chip resistor 82 and capacitor 84 are directly connected coaxially with pin 70 (i.e., with each of front end 76 and rear end 78), and are linearly in the path of a signal traveling through pin 70.

Pin 70 is preferably removable from and insertable into its connection to the signal wire (i.e pin retainer 72). This facilitates repair and allows for easy interchange of the pin/contact if the equalization needs to be changed. This is a significant advantage over the prior art, where pins are not removable and any change or repair necessitates substantial re-wiring.

FIGS. 4A and 4B depict a coaxial contact used for single ended signaling. However, it should be understood that the present invention provides variable pin (contact) placement capability, and that equalized pins may be placed in any layout configuration that is desired. Pins can be sized and spaced to optimize electrical characteristics including capacitance, inductance, impedance, pin-to-pin coupling, pin-to-shell coupling and crosstalk. Equalized pins can also be arranged in optimal individual modules that are then inserted into inserts that are plated to provide grounding/shielding between the modules. A plated, removable backshell is also provided, and the connector is environmentally sealed.

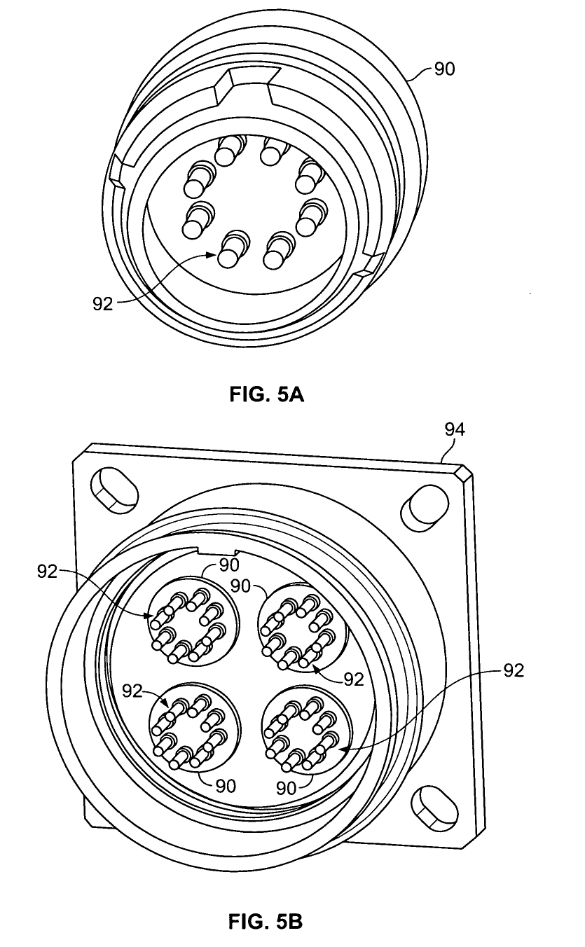

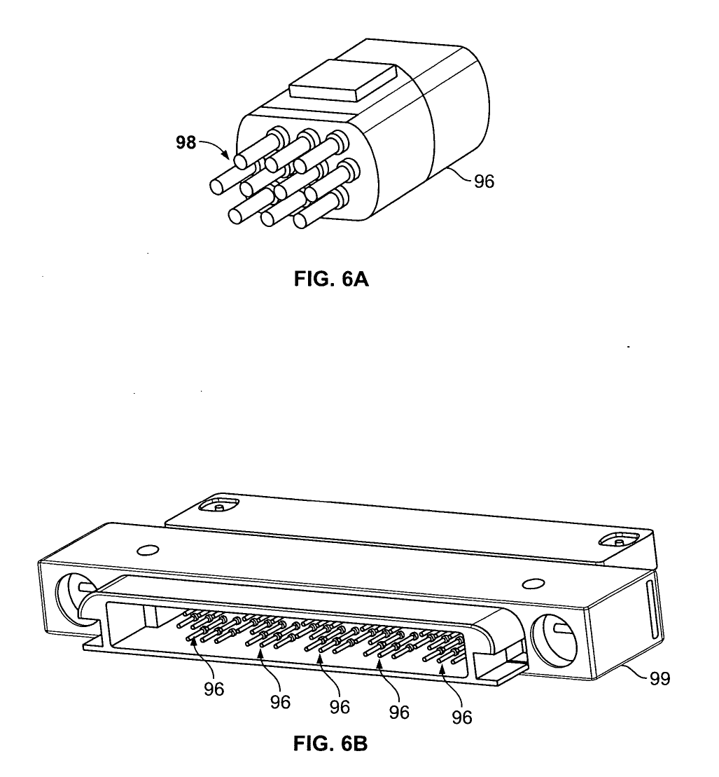

FIGS. 5A-B and 6A-B illustrate several equalized pin layouts. It should be understood that that these are merely exemplary layouts, and that many other layouts are possible and within the scope of this invention. FIG. 5A shows a single multi-pin module 90 having multiple, equalized pins 92. Equalization is applied on a pin-by-pin basis. Thus, all or some of pins 92 would have in-line equalization components formed as discussed with reference to FIGS. 4A-B. FIG. 5B shows a four multi-pin module insert 94, having four multi-pin modules 92, each of which again having some or all of its pins 92 with in-line equalization. FIG. 6A shows a single rectangular connector 96 with multiple, equalized pins 98. FIG. 6B depicts a rectangular connector 99 with six rectangular multi-pin modules 96.

Direct connection of the equalization components to the pins of the connector allows for a very closely matched impedance path for signals coming into and going out of the connector. By manipulating the spacing of the pins, and the dielectric constant of the equalization component composite material, the correct impedance of the receiver/driver can be maintained right up to the leads of the IC. Accurate control of the pin impedance also allows signals to be regenerated, repeated and retimed more accurately, and to be driven farther and faster. A connector with an in-line serial equalization component is simply added inline to allow regeneration of the signal at an appropriate data rate, thereby extending the distance.

Preferably, the wire-contact-equalization-contact attachments are all co-linear axially to provide even greater impedance maintenance. This is in contrast to a configuration such as that disclosed in US 2005/0112920, for example, where signal wires must be bent to be placed along the contacts. Such a non-linear geometry introduces greater impedance into the signal path.

Modification to the particular embodiments of the invention described herein may be made without departing from the spirit and scope of the invention. The described embodiments are illustrative and not restrictive, and the scope of the invention is indicated by the appended claims, rather than the foregoing description. All modifications which come within the meaning and range of equivalency of the claims are therefore intended to be embraced therein.

1. A contact pin for a connector comprising:
first and second pin portions; and
an equalization component directly and serially attached between the first and second pin portions, wherein the equalization components are not mounted to a printed circuit board.

2. A connector comprising the contact pin of claim 1, wherein a cable connector is connected to the first pin portion and a cable wire is connected to the second pin portion, and wherein the connector-pin-equalization-pin-wire signal path is co-linear.

3. A connector as claimed in claim 2, wherein the pin is removable from the cable wire.

4. A contact pin as claimed in claim 1, wherein the equalization component is a chip capacitor, resistor or inductor.

5. A contact pin as claimed in claim 1, wherein the equalization component is soldered directly between the first and second pin portions.

6. A multi-pin module comprising at least one contact pin as claimed in claim 1.

7. A multi-pin module as claimed in claim 6, wherein at least one contact pin is not connected to an equalization component.

8. A multi-pin module as claimed in claim 6, wherein pin placement is optimized for electrical characteristics.

9. A multi-pin module as claimed in claim 6, wherein the multi-pin module has a rectangular or circular shape.

10. A connector comprising:
a first pin portion;
a second pin portion, removably attached to a cable wire; and
an equalization component directly coupled between the first and second pin portions without use of a printed circuit board.

11. A method for forming a connector having a contact pin with an in-line equalization component comprising:
breaking the contact pin into two parts;
directly connecting a contact pin between the two parts without an intermediate component such as a circuit board.

12. A method as claimed in claim 11, wherein one of the two parts is removably connected to a cable wire.

13. A method as claimed in claim 11, wherein the equalization component is soldered between the two parts.
